(19) United States
(12) Patent Application Publication
(10) Pub. No.: US 2019/0205898 A1
(43) Pub. Date: Jul. 4, 2019

(54) DECENTRALIZED CONFIDENTIAL TRANSFER SYSTEM, METHOD AND DEVICE

(71) Applicant: Chronicled, Inc, San Francisco, CA (US)

(72) Inventors: Maurizio Greco, San Francisco, CA (US); Ryan Orr, Brisbane, CA (US); Maksym Petkus, Kyiv (UA); Jon Eric Garvin, San Francisco, CA (US); Susanne Somerville, Corte Madera, CA (US)

(21) Appl. No.: 16/297,507

(22) Filed: Mar. 8, 2019

Related U.S. Application Data
(63) Continuation-in-part of application No. 16/050,833, filed on Jul. 31, 2018.
(60) Provisional application No. 62/539,471, filed on Jul. 31, 2017.
(60) Provisional application No. 62/640,819, filed on Mar. 9, 2018.

(51) Int. Cl. G06Q 30/00; G06Q 20/38

(52) U.S. Cl. CPC G06Q 30/0185; G06Q 2220/00; G06Q 20/3829; G06Q 20/389

(57) ABSTRACT

A system, device and method of confidential secure custodial and/or ownership transfers of asset between entities implemented via an open registry, wherein a ledger securely records each of the transactions utilizing shielded or proxy data state such that information about the transactions cannot be gleaned from the ledger despite the accessible nature of the records on the open registry.

### RELATED APPLICATIONS

This application is a continuation-in-part of U.S. patent application Ser. No. 16/050,833, filed Jul. 31, 2018, and titled “A SECURE AND CONFIDENTIAL CUSTODIAL TRANSACTION SYSTEM, METHOD AND DEVICE USING ZERO-KNOWLEDGE PROTOCOL,” which claims priority under 35 U.S.C. § 119(e) of the co-pending U.S. patent application Ser. No. 62/539,471 filed Jul. 31, 2017, and titled “A METHOD TO VALIDATE SUPPLY CHAIN TRANSACTIONS ACROSS TRADING PARTNERS, VERIFYING END-TO-END PROVENANCE OF TRADING ITEMS WHILE MAINTAINING CONFIDENTIALITY” and the co-pending U.S. provisional patent application Ser. No. 62/640,819 filed Mar. 9, 2018, and titled “DECENTRALIZED ANONYMOUS TRANSFER SYSTEM, METHOD AND DEVICE,” all of which are hereby incorporated by reference.

### FIELD OF THE INVENTION

The present invention relates to the field of decentralized confidential transfers of registered items. More particularly, the present invention relates to confidentially transferring custody or ownership of a recorded identity of a non-fungible item between parties using a decentralized system.

### BACKGROUND OF THE INVENTION

Counterfeit items find their way to the consumer through the supply chain. The challenge of tracking items throughout the supply chain and the inability for its participants to create a proof of possessing goods is a barrier to fight counterfeiting and monitor how items are moving through the supply chain. Ensuring that the item is authentic (i.e., registered by the legitimate party), ensuring that a transfer is valid (i.e., the sender actually owns it and the recipient is the only one receiving it) while maintaining transaction confidentiality are critical properties for a system that can serve multiple industries. Prior implementations of such system require the disclosure of the transactions to a custody registry. Such implementations might be based on simple central databases which might not be desirable because the disclosed information is confidential amongst the parties involved in the transactions. Revealing information such as exchanged assets, commercial volumes, names of business partners, business relationships, upcoming new products and more is a loss of business intelligence and loss of competitive advantage.

### SUMMARY OF THE INVENTION

A system, device and method of confidential secure custodial transfers of asset between registered entities implemented via an open registry (e.g. a blockchain), wherein a ledger securely records each of the transactions utilizing shielded or proxy data state such that information about the transactions cannot be gleaned from the ledger despite the accessible nature of the records on the open registry. As a result, the system, device and method resolves the privacy concern problems inherent in and specific to public ledgers by delivering secure transactions amongst business partners.

A first aspect is directed to a blockchain and digital ownership transfer authentication system for transferring digital identities of items from a sender to a recipient, wherein the sender has a sender secret key and a sender public key that is derived from the sender secret key and the recipient has a recipient secret key and a recipient public key that is derived from the recipient secret key. The system comprises a blockchain including a key-value storage that stores transfer fingerprints and an accumulator that stores the digital identities of the items, wherein each of the digital identities includes an item's first fingerprint that is derived from an item identifier, the sender public key of the sender that is a current custodian of the item and a corresponding randomness entropy value, a sender device storing a first transfer agent and a recipient device storing a second transfer agent, wherein upon selection of a transfer feature by the sender on the sender device, the first transfer agent generates an item's second fingerprint based on the item identifier and the recipient public key, generates a transfer fingerprint based on the sender secret key and the item's first fingerprint, wherein the transfer fingerprint uniquely identifies the transaction, generates at least one sender proof that enables the blockchain to determine whether the sender device knows the item identifier, the sender secret key and the recipient public key and the corresponding randomness entropy value and transmits a transaction message to the recipient device including the sender proof, the item's second fingerprint and the transfer fingerprint.

In some embodiments, upon receipt of the transaction message by the recipient device, the second transfer agent generates at least one recipient proof that enables the blockchain to determine whether the recipient device knows the item identifier and the recipient secret key and transmits a transfer transaction to the blockchain including the recipient proof, the sender proof, the item's second fingerprint and the transfer fingerprint. In some embodiments, the blockchain verifies whether the sender device knows the item identifier, the sender public key, the sender secret key and the recipient public key based on the sender proof and verifies whether the recipient device knows the item identifier and the recipient secret key based on the recipient proof. In some embodiments, the blockchain refrains from recording the transfer transaction on the accumulator if the transfer fingerprint already exists on the key-value storage. In some embodiments, the blockchain refrains from recording the transfer transaction on the accumulator if the item's second fingerprint already exists on the accumulator. In some embodiments, the accumulator is an append-only merkle tree in which each of the digital identities is a leaf of the merkle tree. In some embodiments, the first transfer agent identifies a merkle tree root value and the blockchain refrains from recording the transfer transaction on the accumulator if a leaf that represents the transfer fingerprint does not belong to the merkle tree.

In some embodiments, the item identifier is a tuple comprising a unique identifier value and the registrant public key. In some embodiments, the system further comprises a registrant device storing a registration agent, wherein upon selection of a registration feature by a registrant, the registration agent generates a registration item fingerprint based on the item identifier and a registrant public key of a registrant having a registrant secret key that corresponds to the registrant public key, generates a registrant proof that enables the blockchain to determine whether the registrant device knows the item identifier, the registrant secret key and the corresponding randomness entropy value and transmits a registration transaction to the blockchain including the registration proof and the registration item fingerprint. In some embodiments, the blockchain verifies whether the sender device knows the item identifier, the registrant public key and the registrant secret key based on the registrant proof. In some embodiments, the blockchain refrains from recording the registration transaction on the accumulator if the registrant item fingerprint already exists on the accumulator.

A second aspect is directed to a digital ownership transfer authentication device for transferring digital identities of items from a sender to a recipient on a blockchain, the blockchain including a key-value storage that stores transfer fingerprints and an accumulator that stores the digital identities of the items, wherein each of the digital identities includes an item's first fingerprint that is derived from an item identifier, the sender public key of the sender that is a current custodian of the item and a corresponding randomness entropy value, wherein the sender has a sender secret key and a sender public key that is derived from the sender secret key and the recipient has a recipient secret key and a recipient public key that is derived from the recipient secret key. The device comprises a non-transitory computer-readable memory storing a transfer agent having a graphical user interface and including transfer and registration functions and a processing circuit coupled with the memory, wherein when executed by the processing circuit and upon selection of a transfer feature when the sender is logged into the transfer agent, the transfer agent generates an item's second fingerprint based on the item identifier and the recipient public key, generates a transfer fingerprint based on the sender secret key and the item's first fingerprint, wherein the transfer fingerprint uniquely identifies the transaction, generates at least one sender proof that enables the blockchain to determine whether the sender device knows the item identifier, the sender secret key, the recipient public key and the corresponding randomness entropy value and generates a transaction message including the sender proof, the item's second fingerprint and the transfer fingerprint.

In some embodiments, upon receipt of the transaction message from a sender device when the recipient is logged into the transfer agent, the transfer agent generates at least one recipient proof that enables the blockchain to determine whether the transfer agent knows the item identifier and the recipient secret key and transmits a transfer transaction to the blockchain including the recipient proof, the sender proof, the item's second fingerprint and the transfer fingerprint. In some embodiments, the blockchain verifies whether the sender device knows the item identifier, the sender public key, the sender secret key and the recipient public key based on the sender proof and verifies whether the recipient device knows the item identifier and the recipient secret key based on the recipient proof. In some embodiments, the accumulator is organized into an append-only merkle tree in which each of the digital identities is a leaf of the merkle tree and when the sender is logged into the transfer agent, the transfer agent identifies a merkle tree root value and includes the merkle tree root value in the transaction message. In some embodiments, the item identifier is a tuple comprising a unique identifier value and the registrant public key. In some embodiments, when a registrant is logged into the transfer agent and selects a registration feature, the transfer agent generates a registration item fingerprint based on the item identifier and a registrant public key of a registrant having a registrant secret key that corresponds to the registrant public key, generates registrant proof that enables the blockchain to determine whether the registrant device knows the item identifier, the registrant secret key and the corresponding randomness entropy value and transmits a registration transaction to the blockchain including the registration proof and the registration item fingerprint.

A third aspect is directed to a method of implementing a blockchain and digital ownership transfer authentication system for transferring digital identities of items from a sender to a recipient on a blockchain, the blockchain including a key-value storage that stores transfer fingerprints and an accumulator that stores the digital identities of the items, wherein each of the digital identities includes an item's first fingerprint that is derived from an item identifier, the sender public key of the sender that is a current custodian of the item and a corresponding randomness entropy value, wherein the sender has a sender secret key and a sender public key that is derived from the sender secret key and the recipient has a recipient secret key and a recipient public key that is derived from the recipient secret key. The method comprises generating with a sender device having a first transfer agent an item's second fingerprint based on the item identifier and the recipient public key, generating with the sender device a transfer fingerprint based on the sender secret key and the item's first fingerprint, wherein the transfer fingerprint uniquely identifies the transaction, generating with the sender device at least one sender proof that enables the blockchain to determine whether the sender device knows the item identifier, the sender secret key, the recipient public key and the corresponding randomness entropy value and transmitting with the sender device a transaction message to a recipient device having a second transfer agent, the transaction message including the sender proof, the item's second fingerprint and the transfer fingerprint.

In some embodiments, the method further comprises, upon receipt of the transaction message by the recipient device generating with the recipient device at least one recipient proof that enables the blockchain to determine whether the recipient device knows the item identifier and the recipient secret key and transmitting with the recipient device a transfer transaction to the blockchain including the recipient proof, the sender proof, the item's second fingerprint and the transfer fingerprint. In some embodiments, the method further comprises verifying with the blockchain whether the sender device knows the item identifier, the sender public key, the sender secret key and the recipient public key based on the sender proof and verifying whether the recipient device knows the item identifier and the recipient secret key based on the recipient proof. In some embodiments, the method further comprises refraining from recording the transfer transaction on the accumulator if the transfer fingerprint already exists on the key-value storage. In some embodiments, the method further comprises refraining from recording the transfer transaction on the accumulator if the item's second fingerprint already exists on the accumulator.

In some embodiments, the accumulator is an append-only merkle tree in which each of the digital identities is a leaf of the merkle tree. In some embodiments, the method further comprises identifying a merkle tree root value with the first transfer agent and refraining from recording the transfer transaction on the accumulator if a leaf that represents the transfer fingerprint does not belong to the merkle tree. In some embodiments, the item identifier is a tuple comprising a unique identifier value and the registrant public key. In some embodiments, the method further comprises upon selection of a registration feature of a registration agent on a registrant device by a registrant generating with the registrant device a registration item fingerprint based on the item identifier and a registrant public key of a registrant having a registrant secret key that corresponds to the registrant public key generating with the registrant device a registrant proof that enables the blockchain to determine whether the registrant device knows the item identifier, the registrant secret key and the corresponding randomness entropy value and transmitting with the registrant device a registration transaction to the blockchain including the registration proof and the registration item fingerprint. In some embodiments, the method further comprises verifying with the blockchain whether the sender device knows the item identifier, the registrant public key and the registrant secret key based on the registrant proof. In some embodiments, the method further comprises refraining from recording the registration transaction on the accumulator if the registrant item fingerprint already exists on the accumulator.

### BRIEF DESCRIPTION OF THE DRAWINGS

FIG. 1 illustrates a decentralized confidential transfer system according to some embodiments.

FIG. 2 illustrates a block diagram of an exemplary computing device configured to implement the system according to some embodiments.

FIG. 3 illustrates a method of operating a secure transfer system according to some embodiments.

FIG. 4 illustrates another portion of a method of operating a secure transfer system according to some embodiments.

### DETAILED DESCRIPTION OF THE INVENTION

Embodiments described herein are directed to a system, device and method of confidential secure custodial and/or ownership transfers of asset between registered entities implemented via an open registry (e.g. a blockchain). In particular, a ledger that securely records each of the transactions utilizes a shielded or proxy data state such that information about the transactions cannot be gleaned from the ledger. As a result, the system is necessarily rooted in the computer technology of open registry records to overcome the problem of the necessary public nature of the records a problem specifically arising in open registries due to their publically accessible recording nature. In particular, the system provides the benefit of overcoming this inherent lack of confidentiality of an open registry transaction recording technology by providing a protective layer of confidentiality the open registry only displaying a proxy status of transactions, wherein the actual identifiers of the transactions cannot be derived from the proxy status without a set of generated proofs that are not provided by the open registry. As used herein, the term “custody” is able to include or be replaced with “ownership.”

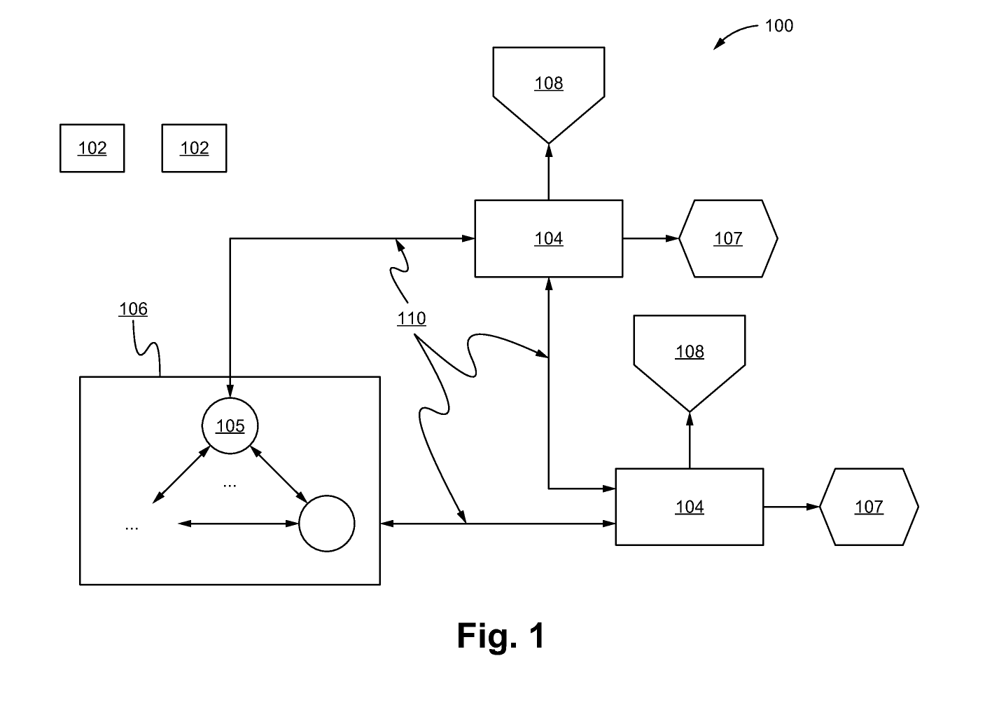

FIG. 1 illustrates a decentralized confidential transfer system 100 according to some embodiments. As shown in FIG. 1, the system 100 is able to comprise one or more physical or virtual assets/items 102 each having one or more identification data, an open registry 106 (e.g. a blockchain network) including one or more nodes 105, one or more transfer devices 104 each having a transfer agent 107, and one or more storage devices/servers storing secure storage databases 108, all communicatively coupled together via one or more networks 110 (e.g. the internet, a private wireless connection, a wired network). In some embodiments, the identification data is able to comprise an item identifier and/or a public and secret key pair (as described in detail below). Alternatively, other identifiers are able to be used as the identification data. Each of the secure storage databases 108 are able to be a database which allows keeping secret data artifacts necessary for transaction generation, such as secret keys, seeds for pseudo-random function, or other data. In some embodiments, the storage devices/servers 108 storing the databases are able to wholly or partially separate from one or more of the nodes 105 and/or devices 104. Alternatively, the storage devices/servers 108 are able to be one or more of the nodes 105, the devices 104 or other computing devices separate from the devices 104/registry 106 (e.g. dedicated secure storage database devices). For example, the storage devices/servers 108 are able to be a memory of the devices 104 and/or the nodes 105 such that the database is stored on the devices 104 and/or the nodes 105.

Although as shown in FIG. 1, the registry 106 is coupled with two client transfer devices 104 (and the agents 107 operating thereon), it is understood that any number of registries 106 are able to be coupled with any number of transfer devices 104. The networks 110 are able to be one or a combination of wired or wireless networks as are well known in the art. For example, the networks 110 are able to comprise a wired or wireless private peer-to-peer connection for conveying secret information between a sender device 104 and a recipient client device 104, necessary to execute transfer transaction and other interactions between devices 104.

One or more servers are able to store/operate at least a portion of the transfer agents 107 including a graphic user interface on a memory of one or more of the servers (e.g. nodes 105). As a result, a user is able to download the agent 107 from the servers over the network 110 onto one or more of the transfer devices 104. After being downloaded to the client transfer device 104, the agent 107 is able to create and use an application database within the local memory on the transfer device 104 to store and utilize data necessary for operation.

Alternatively, some or all of the data is able to be stored in a server database on the memory on the servers such that the agent 107 is able to connect to the servers over the networks 110 in order to utilize the data on the server database. For example, the locally executing agent 107 on the transfer devices 104 is able to remotely communicate with the servers over the network 110 to perform any features of the agent 107 and/or access any data on the server database not available with just the data on the transfer device 104. In some embodiments, the same data is stored on both the server database and one or more of the transfer devices 104 such that either local or remote data access is possible. In such embodiments, the data on the servers and/or transfer devices 104 is able to be synchronized by the application. In some embodiments, the server database and/or agent 107 is distributed across a plurality of the servers. Alternatively or in addition, one or more of the servers are able to store all of the database and/or application data. In such embodiments, the servers are able to perform a synchronization process such that all the databases and/or other application data are synchronized.

Alternatively, the agent 107 is able to be replaced or supplemented with a website stored on the server memory and executed by the servers, wherein the website provides some or all of the functionality of the agent 107 with a website user interface that is substantially similar to the application/agent user interface. In such embodiments, a transfer device 104 is able to access the website and utilize the features of the agent and/or website with a web browser that communicates with the servers over the networks 110. In some embodiments, the functionality of the website is able to be limited to facilitating the downloading of the agent 107 onto one or more transfer devices 104. In other words, the application/agent 107 is able to operate on just the servers, just the transfer devices 104 or a combination of the servers and transfer devices 104. Accordingly, it should be noted that although described according to an exemplary functional distribution herein, other distributions of the functions of the application/agent 107 between the servers (via the website) and the transfer devices 104 (via the application) are contemplated but not included for the sake of brevity. In some embodiments, the items 102 are able to be an autonomous machine such as a drone or an identity/internet of things (IOT) device. In some embodiments, the agent 107 is able to be already installed in the transfer device 104 or is able to be part of the software or firmware operating the transfer device 104 itself.

The transfer devices 104 are able to be any transfer device having a memory for storing at least a portion of the agent 107. In some embodiments, the devices 104 comprise a display (e.g. a touchscreen). Examples of suitable transfer devices 104 capable of storing the agent 107 include smart jewelry (e.g., smartwatch), a personal computer, a laptop computer, a computer workstation, a server, a mainframe computer, a handheld computer, a personal digital assistant, a cellular/mobile telephone, an IOT device, a smart appliance, a game console, a digital camera, a digital camcorder, a camera phone, a smart phone, a portable music player, a tablet computer, a mobile device, a video player, a video disc writer/player (e.g., DVD writer/player, high definition disc writer/player, ultra high definition disc writer/player), a television, a home entertainment system or any other suitable transfer device. In some embodiments, the transfer devices 104 are able to include a wireless tag reading feature capable of wirelessly reading and/or communicating with the tags or identifiers coupled to the items 102. For example, the transfer devices 104 are able to communicate wirelessly with the tags/labels via one or more of near field communication, sub-gigahertz frequencies, Bluetooth low energy (BLE), radio frequency identification (RFID), Bluetooth, Wi-Fi or other types of wireless communication known in the art. Further, the devices 104 are able to be integrated into supply chain equipment (e.g., bar code scanner, optical character recognition (OCR) readers, RFID readers, near field communication (NFC) readers, convey belts, packaging machines) that is able to read and/or write data to the targeted open registry 106, transaction ledger, tags 103 and/or servers.

The items 102 are able to be physical objects (e.g. receptacles, containers, parcels, envelops, packages, boxes, and any cases that might hold products or components that form a device, machine, apparatus or utensil) having one or more cavities for storing food, medicine, medical samples, evidence or other items and sealing elements for selectively sealing/unsealing the cavities (e.g. zippers, doors, covers, sliders, lids, flaps, and other types of sealing appendages known in the art). Alternatively or in addition, the items 102 are able to be goods, IOT devices, apparel, shoes, hand bags, garments, products and/or other physical items. For example, the items are able to be bars of gold bullion or athlete drug test samples. Alternatively, the items 102 are able to be virtual items/assets (e.g. intellectual property, songs, data objects).

In some embodiments, the identification data of the items 102 is able to be stored on one or more tags or labels coupled to the items 102. In such embodiments where the items 102 have tags storing some or part of the identification data, the tags are able to be substantially similar to the tags described in U.S. patent application Ser. No. 15/785,086, filed Oct. 16, 2017 and entitled “OPEN REGISTRY FOR PROVENANCE AND TRACKING OF GOODS IN THE SUPPLY CHAIN,” which is hereby incorporated by reference. In such embodiments, the tags and the transfer devices 104 are able to communicate wirelessly via near field communication, Bluetooth low energy (BLE), radio frequency identification (RFID), Bluetooth, Wi-Fi or other types of wireless communication known in the art.

In some embodiments where the identification data includes a secret and public key pair, the secret key of the items 102 is able to be an encryption key that is associated with the corresponding public key of the items 102. In other words, the public key and secret key are related such that data encrypted with the public key are only able to be decrypted using the secret key and digital signatures generated by the secret key are only able to be validated using the public key. In some embodiments where the identification data includes an item identifier separate from or in lieu of the secret/public key pair, the item identifier of the items 102 is able to be a SGTIN, the public key (associated with the secret key stored on the tag), a hash of the public key, a universally unique identifier (UUID), another unique identifier or a combination thereof. In some embodiments, some or all of the identification data is able to be printed, imprinted or applied via one or more labels to an exterior surface of the item 102.

The registry 106 is able to be a decentralized network of nodes 105 that provide the maintaining of a copy of a distributed ledger on each node. Each node 105 is able to comprise a device (e.g. server or other computing device) storing and operating a registry agent which is capable of connecting to peer nodes 105, executing transactions and achieving decentralized consensus on the state of the ledger. For example, the nodes 105 are able to perform verification of a zero-knowledge proof utilizing their agent. Specifically, a non-interactive zero-knowledge proof is a mathematical construction which allows proving that for some function f( ), the prover knows input such that it satisfies verifier's output (i.e. f(input)=output). Examples of some of non-interactive zero-knowledge proof methods are zk-SNARK, Bulletproofs, zk-STARK.

In some embodiments, the open registry 106 is able to be substantially similar to the open registry described in U.S. patent application Ser. No. 15/785,086, filed Oct. 16, 2017 and entitled “OPEN REGISTRY FOR PROVENANCE AND TRACKING OF GOODS IN THE SUPPLY CHAIN,” except for the differences described herein. Specifically, the open registry 106 is able to store registry data and is able to be a database, a public blockchain, a secret blockchain (where different classes of users may have different levels of access to data records written to the chain), and/or a collection of smart contracts whose records are open to the public (e.g. access to view records is not permission based, but ownership transfer protocol requirements for making changes to database).

For example, the registry 106 is able to be a distributed database (e.g. across a plurality of computing devices that each store copies of transactions in one or more linked blocks) that maintains a continuously-growing list of data records or contracts (e.g. item information of the items associated with the unique identifiers, provenance or chain of ownership/custody transactions associated with pairs of public keys and unique identifiers, digital signatures of a person/identity utilizing the pairs of public keys and unique identifiers) hardened against tampering and revision. In particular, the open registry 106 is able to be a blockchain with a built-in Turing-complete programming language, allowing anyone to write smart contracts (e.g. cryptographic “boxes” that contain value and only unlock it if certain conditions are met) and decentralized applications where they can create their own arbitrary rules for ownership, transfer formats and state transition functions. As a result, in such embodiments, the open registry 106 is able to both be used to securely identify entities (e.g. registrants, items, devices) based on stored public keys and to securely record changes of custody of items 102 based on designated contracts on the registry 106 associated with the items 102.

In some embodiments, the registry 106 consists of data structure blocks which hold exclusively data or proxy data (e.g. proxy ownership data, item identification data) with each block holding batches of individual transactions and the results of any blockchain executables. Alternatively, the blocks are able to store both data and programs/scripts (e.g. smart contracts). Each block of the blockchain contains a timestamp and information linking it to a previous block (and indicating a time of the transaction) thereby defining the chain and maintaining a chronological order of each of the records/transactions. Alternatively, the open registry 106 is able to be a non-blockchain database.

The registry data is able to comprise a ledger including pairs of data representing items 102 and the current and/or past custodian of those items 102. For example, as described in detail below, items 102 are able to be registered on the ledger with an initial custodian/registrant being associated with the item 102. This association is able to be kept confidential by the ledger recording the results of functions/hashes applied to the actual data (e.g. an item identifier hash representing the item identifier and a custodian hash representing the custodian identifier) such that the actual data can only be determined using proofs designed to decode/reverse the functions/hashes. As a result, the ledger is able to confidentially record each change of custody of an item 102 (e.g. as executed/verified/recorded by a custody smart contract or other function of the registry) is able to be reflected on the chain of custody on the registry 106 for that item 102 indicating one or more of a timestamp, the item identifier, a new custodian identifier and/or other information about the item 102, the new custodian, the previous custodian or the transaction itself. In some embodiments, the ledger is able to comprise an accumulator (e.g. one or more merkle trees) and a key-value storage.

In some embodiments, upon registering with the server and/or registry 106, users are given a public and secret key pair, wherein the secret key is a sufficiently large random number and the public key is a fingerprint of the secret key. Specifically, a fingerprint is the output of a deterministic one-way function, which when the one-way function is given an input it produces the output, from which it is infeasible to compute the input. Determinism ensures that the output is always the same for the same input. Thus, the public and secret keys are related via the one-way function with the secret key being the input and the public key being the output that cannot be feasibly determined based on the output (i.e. public key). As a result, the public key is able to serve as the digital identity of the user (i.e. entity) on the registry and the secret key is used by the user to identify itself (e.g. digitally sign or otherwise authenticate messages to the registry 106 and/or other users). In other words, data encrypted with the public key is only able to be decrypted using the secret key and digital signatures generated by the secret key are only able to be validated using the public key. In some embodiments, the user identifiers on the open registry 106 are able to be implemented via public keys, secret keys, digital certificates (e.g. X.509 certificates), username-password or a combination thereof.

In some embodiments, the registry 106 comprises smart contracts that implement the functionality described herein. Specifically, the smart contracts are able to comprise “registration” contracts and/or “transfer” contracts that define and enforce rules of registering and/or transferring digital custody of an item 102 as reflected on the registry 106. In particular, in order for a change in custody to be executed or added to the open registry 106 (e.g. on the chain of custody for that item 102), a current custodian and/or the receiving custodian (e.g. custodian devices 104) are able to be required by the registry 106 (e.g. via a smart contract) to submit data satisfying the change of custody requirements. For example, the contracts are able to require proof that the item 102 has not been previously registered, that the digital identity indicated by transferor is the current custodian (as indicated on the registry 106), identification of the desired transferee (e.g. digital identity), proof by the transferee as being the desired transferee upon receiving the item 102, and/or any other requirements (e.g. times, dates, quantities, payments received). As another example, the custody requirements are able to require that only one participant can have custody of an identifier at any given time, only the current custodian can transfer an identifier, a transfer is not executed until an identifier is accepted by the recipient, and/or optionally, only certain entities (e.g., manufacturers) can create identifiers in the system. In other words, each smart contract on the registry 106 is able to enforce business rules, maintain an obfuscated image that proxies the truthful state of the system 100, and accept, validate and commit transactions that comply with the business rules and the current state of the system 100. It should be noted that although as described herein, smart contracts perform the functionality of the registry 106 (e.g. blockchain), it is understood that the registry 106 functionality is able to be implemented by other types of executable programs in combination with or separate from the use of smart contracts.

As described in detail below, the transfer agents 107 are able to accept secret inputs and produce a zero-knowledge proof for the desire non-deterministic polynomial time (NP) statement. In some embodiments, the transfer agents 107 are able to include the features described in U.S. patent application Ser. No. 15/785,086, except for the differences described herein. Specifically, the agent 107 is able to comprise a register function, a transaction function, a receiver function and/or a verification function, wherein the application user interface is configured to enable users to utilize the functions/modules. The agent 107 and the functions are able to use the databases 108 to store, maintain and access data necessary for the operation of the agent 107. As a result, the transfer agent 107 enhances the functionality of the devices 104 themselves by enabling them to securely register and transfer digital custody of items 102 without exposing confidential or other data that would give others a competitive advantage.

The Registration Function

The registration function enables the device 104 to register itself (e.g. to create one or more user/device accounts on the registry 106) and to register items 102 on the registry 106. Alternatively or in addition, instead of the registry 106, the agent 107 on the device 104 itself is able perform the registration and store the registration information as described in detail below (e.g. identity, secret/public keys). Specifically, the registration function enables the device 104 to create a user profile/account by inputting username and password information via the graphical user interface that is then associated with the account such that the information is able to be used to identify the user when logging onto the application. Alternatively, the login information is able to be omitted and a user is able to use the agent 107 without creating a user account or logging in. After a user account is created, the user is able to be assigned a unique user identifier (e.g. a secret and public key pair and/or another unique identifier), wherein the unique user identifier is added to the registry to create the device/user's digital identity. In some embodiments, the unique user identifier is stored on the transfer agent 107 on the device 104 when registering. Accordingly, the user is then able to access their account by entering the username, password and/or user identifier in order to identify themselves to the agent 107.

In some embodiments, during the creation of the account or subsequently, additional information is able to be stored and associated with the account such as, but not limited to, contact information (e.g. phone number, email, address), submitted content (e.g. item images, descriptions), account privileges/subscription information (e.g. unlocked application features), friends or other trusted accounts on the system and payment information (e.g. currency/bank accounts for receiving/transmitting currency based on the smart contracts). In some embodiments, the additional information is submitted by a user upon logging into the account. Alternatively, some or all of the additional information is able to be applied to the account automatically by the agent 107 based on interactions by the user with the agent 107.

Further, the registration function enables the device 104 to register one or more items 102 in order to create digital identities for the items 102 on the registry 106 and associate those digital identities with a current custodian (e.g. the registrant). Specifically, in order to register an item 102, using a unit commitment function COMMₓ( ) of the agent 107, a device 104 of the registrant generates an item ownership fingerprint (iof) based on the item identification data (e.g. the item identifier) of the item 102 and the public key of the registrant/registrant device 104 (e.g. item ownership fingerprint=COMMₓ(item identification data, public key) where x is the randomness seed for the function). In some embodiments, the unit commitment function is a statistically-hiding commitment scheme.

For example, given a randomness r and p, the unit commitment function is able to be as follows:

(1) item ownership fingerprint (iof)=COMMᵣ(id∥aᵣₖ∥p);

where a is a tuple (aᵣₖ, aₛₖ), a cryptographic keypair which in some embodiments represents the participant's p address (public key pk and secret key sk), for example, with aₛₖ being sampled randomly using a cryptographically secure random number generator and aᵣₖ=public key function PRFaₛₖ(0), where PRF is a cryptographic pseudo-random function that is collision resistant; id is a tuple (uid, aᵣₖ) (e.g. tuple (item identification data, registrant public key)); and p is the seed for transfer artifact function PRFₓ( ). Specifically, the public key of the registrant aᵣₖ is used in the id tuple such that it enables any participant is subsequent transactions to identify the registrant of the item 102. This yields an item representation u=(id, aᵣₖ of the registrant, r, p, iof).

As a result, the created item ownership fingerprint is able to represent both the item 102 (e.g. via the item identifier) and its owner (e.g. via the public key). As described above, a fingerprint is the output of a deterministic one-way function, which is given an input produces an output, from which it is infeasible to compute the input. In particular, this is an example of the folded fingerprint where it combines some input (item identity) and another fingerprint (e.g. the public key (which is a fingerprint of the secret key)). The term “combine” is used here to convey the meaning of “comprising,” wherein an implementation example is able to be the concatenation of the item identifier and the public key. In some embodiments, the registrant inputs the public key and/or the item identifier to the agent 107 via the user interface of the agent 107. Alternatively, the public key and/or the item identifier are able to be wirelessly read from the item 102 (e.g. via a tag coupled to the item 102 that stores the data) using a wireless reader of the device 104.

Next the agent 107 creates a proof for the generated item ownership fingerprint based on the unit commitment function COMMₓ( ), the item identifier and the secret key of the registrant using a non-interactive zero-knowledge proof (ZPK) proving function, wherein the proving function is configured for the unit commitment function COMMₓ( ). Specifically, a ZKP proving function (i.e. proof=Prove(COMMₓ( ), secret input) is a program that allows the device 104 to produce a proof value for a function f( ) (e.g. unit commitment function) and the secret input (e.g. secret key), wherein the proof generated by the proving function is obscure data that then enables another device/agent (e.g. the registry 106) to use a ZKP verification function to verify whether the proof value corresponds to the output (e.g. public key) of the function f( )(e.g. unit commitment function) without the other device/agent knowing the input (e.g. secret key) to that function. In other words, the ZKP verification function (e.g. verify(f( ) output, proof)) enables a verifier device/agent, having access to the function f( ) the output (e.g. item ownership fingerprint) and the proof value (but not the input to the function f( ), to determine if the proof value corresponds to the output (where f(input)=output). In some embodiments, a user inputs the secret key and/or the item identifier to the agent 107 via the user interface of the agent 107.

For example, the ZKP proving function is able to create a proof π_{registration} for the registration NP statement:

“given the item ownership fingerprint, I know item representation u and secret key aₛₖ such that:
the address of the secret key corresponds to the public key (i.e. aₚₖ=public key function PRFaₛₖ(0)); and
for u, the iof=COMMᵣ(id∥aₚₖ∥p) COMMᵣ(uid∥aₚₖ∥aₚₖ∥p).”
   Explicitly, the instance tuple is (iof), wherein the instance tuple comprises public input which when combined with a verification key enables a verifier (e.g. the registry 106) to verify if the proof satisfies the NP statement (e.g. {0, 1}∃f(verification key, it, public input)) and the witness tuple is (aᵣₖ, aₛₖ, uid, r, p), wherein the witness tuple comprises secret input which when combined with a proving key enables the agent 107 to generate a proof for the witness input (e.g. proof 7C=f(proving key, secret input)).

The agent 107 then sends the item ownership fingerprint and the item ownership fingerprint proof to the open registry 106 as a new transaction. Before accepting the new transaction, the transaction is verified by the smart contract of the registry 106 using the ZKP verification function (which like the proving function is configured for the unit commitment function) based on the item ownership fingerprint, the unit commitment function COMMₓ( ), and the item ownership fingerprint proof. Specifically, the registry 106 determines if that the registrant knows both the item identifier and the secret key. For example, the smart contract is able to:
parse the registration message tx_{registration} on as (iof, proof π_{registration});
verify that the iof does not already appear on the accumulator; and
verifying that Verify(registration verification key, iof, proof π_{registration})=accepted for the NP statement.
   If the verification fails (e.g. either because results of entering the proof value into the verification function did not match the fingerprint or because the item ownership fingerprint or the proof matches an already registered item ownership fingerprint or proof) the transaction will be rejected, otherwise the item ownership fingerprint is appended to the accumulator of the registry 106 (thereby associating the item 102 with the registrant).

### The Transaction Function

The transaction function enables the device 104 to transfer items 102 on the registry 106 (e.g. associate a different user identifier with an item identifier) by creating a new item ownership fingerprint that identifies the new/recipient user and the item 102. Specifically, the transfer function involves two users/devices 104, the sender and the recipient (each having public/secret key pairs), and requires the sender to prove that he is indeed the current owner of the item 102 by producing the new item ownership fingerprint for the recipient.

As a first step, the agent 107 of the sender device 104 identifies an item to transfer as represented by a particular item ownership fingerprint on the accumulator (e.g. an item ownership fingerprint that has already been registered and appended to the accumulator) and/or a recipient to transfer the item 102 to (e.g. a public key of the recipient). In some embodiments, the user interface of the agent 107 comprises a transfer feature that prompts the user to select a desired item 102 to transfer and/or user to transfer to. In particular, the user interface of the agent 107 is able to display a list of items 102 and/or users associated with the digital identity (e.g. public key/secret key) of a user that logged into the agent 107 (e.g. by entering a username and password, a public and/or secret key or derivation thereof, or other logging in methods).

Upon providing the agent 107 with the desired item 102 to transfer, the agent 107 determines the item identity data, sender secret key, recipient public key and the accumulator membership proof for the item's fingerprint, the agent 107 of the sender device 104 uses a transfer function to generate a new item ownership fingerprint for the selected item 102 based on the item identity and recipient public key. In some embodiments, the item identity is manually entered by a user via a user interface of the agent 107 of the sender device 104. Alternatively or in addition, the item identity is able to be determined by reading data from the item 102 (e.g. scanning a barcode, reading data from an RFID tag on the item 102, etc.) and/or via a software application (e.g., ERP system) provides the item identity based on a business process, software function triggered by a user or event, or—more in general—by any business logic. In some embodiments, the agent 107 remotely accesses the recipient public key from the ledger, other storage of the registry 106 and/or a separate key database. Alternatively, some or all of the key value storage is able to be stored locally on the device 104 and synchronized periodically such that the agent 107 is able to locally access the recipient public key. In some embodiments, if there is a plurality of key value storages, a user selects one from a plurality of possible key value storages for the transfer via the agent 107. Alternatively, the agent 107 is able to automatically select a desired key value storage (e.g. based on where the item 102 is “tracked”).

For example, the agent 107 is able to obtain new randomness values r and p, and in the same manner as during the registration process except using the public key of the recipient and the new random values, generate a new item ownership fingerprint (iof_{new}) where iof_{new}=COMMᵣ(id∥aₚₖ∥p). As a result, a new item representation is generated where u_{new}=(id, aₚₖ of the recipient, r, p, iof_{new}). In some embodiments, the agent 107 is configure to only generate the new item ownership fingerprint if and only if the old item ownership fingerprint exists in the key value storage (i.e. passes the membership test). Specifically, the agent 107 is able to first determine the old item ownership fingerprint based on the item identity and sender public key (which can be deduced from the received sender secret key input).

The agent 107 of the sender device 104 also generates a transfer fingerprint sn for the transaction that can uniquely identify the transaction. Specifically, the agent 107 uses a transfer artifact function to generate the transfer fingerprint based on the old item ownership fingerprint, the sender secret key and the unit commitment function COMMₓ( ). The agent 107 is able to determine/identify the old item ownership fingerprint (either stored locally on the device 104 or remotely accessible by the agent 107) because it was previously received by the device as a part of a previous transfer message that was transmitted to the device 104 (from another device/agent) when the item was being transferred from the other device to the current device. Alternatively, the device 104 is able to store/remotely access the secret data upon which the old item ownership fingerprint was based and reconstruct the fingerprint based on that data.

If the transaction goes through, this transfer fingerprint is able to represent the old iof for the item 102 on the key value storage and is flagged as being “consumed” as an indicator that the old iof can no longer be used as a source for any future transfer. The transfer fingerprint is generated in a way that is deterministic and distinct from item ownership fingerprint, wherein distinct in this context relates to the registration function, which generally uses same input parameters as the transfer artifact function, hence the way it combines those parameters influences the resulting fingerprint. While there are multiple ways to achieve deterministic distinct output and a particular choice is the matter of implementation, the core property is the unlinkability (or inability to correlate) between transfer fingerprint and item ownership fingerprint despite being based on the same factors.

For example, in some embodiments the transfer artifact function is the transfer fingerprint sn=serial number function PRFaₛₖ (iof_{old}∥p_{aid}). In particular, this provides the benefit of the resulting transfer fingerprint value not revealing a link to the iof_{old} (i.e. the transfer fingerprint cannot be determined as being related to any particular iof). In other words, the generation of the transfer fingerprint is able to prove that the item 102 has not been transferred already (i.e. ensuring that the sender is the current “custodian” of the item 102 on the key value storage and thus that the item 102 is not associated two different user identities at the same time). Specifically, the transfer fingerprint can be compared to all the previously submitted transfer fingerprints on the registry 106 to ensure that the same transfer fingerprint is not submitted/used twice. This is important since the old item ownership fingerprint is not required for the transfer and therefore the source of transfer is obfuscated. While in some embodiments the transfer and transfer artifact functions are able to be combined into one function, we describe them separately for simplicity.

Next the agent 107 of the sender device 104 creates a sender proof. The transfer statement is based on the item identity, sender secret key, recipient public key using the non-interactive zero-knowledge proof (ZPK) proving function.

For example, the ZKP proving function is able to create a proof π_{sender} for the registration NP statement:

“given the merkle tree root rt, transfer fingerprint sn and new item ownership fingerprint iof_{new}, I know item representation u_{old} (representing the current item association/custody on the merkle tree), u_{new} (representing the new item association/custody) and secret key aₛₖ (of the sender) such that:
the iof_{old} appears as a leaf of the merkle tree with root rt;
the sender secret key corresponds to the public key: (i.e. aₚₖ=public key function PRFaₛₖ(0), where aₛₖ is the secret key of the sender);
the secret values of u_{old} are known, such that: iof_{old}=COMMr_{old} (id∥aₚₖ∥p_{old}), where aₚₖ is the public key of the sender;
the transfer fingerprint sn is computed correctly: (i.e. sn=transfer artifact function PRFaₛₖ(iof_{old}∥p_{old}), where aₛₖ is the secret key of the sender);
the values of u_{new} are known, such that: iof_{new}=COMM_{rnew}(id∥aₚₖ∥p_{new}), where aₚₖ is the public key of the recipient.”

Explicitly, the instance tuple is (rt, sn, iof_{new}) and the witness tuple is (iof_{old}, aₚₖ of sender, aₛₖ of sender, id, r_{old}, p_{old}, aₚₖ of recipient, r_{new}, p_{new}).

Subsequently, the agent 107 of the sender device 104 transmits a transfer message to the recipient device 104 though the network (e.g. network 110). As a result, as described above, the recipient device 104 is able to store the transfer message and the data therein for use in subsequent transfers (e.g. use the knowledge of the received fingerprint value of an item for executing a subsequent transfer of the item where it is the sender device 104 of the item). Specifically, the transfer message includes all of the values necessary for the recipient to complete the transfer. For example, the message is able to be m_{transfer}=(id, aᵣₖ, r_{new}, A_{new}, rt, sn, iof_{new}, π_{sender}), where aₚₖ is the public key of the recipient). In particular, this method provides the advantage that even though the sender device 104 samples random values for the recipient's u_{new}, they will not be able to compute the transfer fingerprint sn and therefore will not be able to discover when iof_{new} is transferred further, due to the seed aₛₖ of the transfer artifact function PRFₓ( ).

From this point, the recipient device needs to approve the transfer in order for it to be recorded on the ledger of the registry 106. Specifically, the agent 107 of the recipient device 104 verifies that the received iof_{new} is correct (e.g. iof_{new}=COMM_{rnew}(id∥aᵣₖ∥p_{new}), where aᵣₖ is the public key of the recipient and then produces a proof π_{recipient} for a destination NP statement using the non-interactive zero-knowledge proof (ZPK) proving function.

For example, the ZKP proving function is able to create the proof π_{recipient} for the registration NP statement: “given the new item ownership fingerprint iof_{new}, I know u_{new} (representing the new item association/custody) and secret key aₛₖ (of the recipient) such that:
the new item ownership fingerprint is computed correctly: iof_{new}=COMM_{rnew}(id∥aᵣₖ∥p_{new}), where aᵣₖ is the public key of the recipient;
the recipient address secret key corresponds to the public key: (i.e. aᵣₖ=public key function PRFaₛₖ(0), where aₛₖ is the secret key of the recipient).”
   Explicitly, the instance tuple is (iof_{new}) and the witness tuple is (aᵣₖ of recipient, aₛₖ of recipient, id, r_{new}, p_{new}).

Subsequently, the recipient devices transmit 104 a transaction message m_{transaction} to the registry 106 (via the agent 107), the transaction message comprising the root of the merkle tree for the item 102, the transfer fingerprint, new item ownership fingerprint, transfer artifact function proof and transfer function proof. For example, the transaction message is able to comprise m_{transaction}=(rt, sn, iof_{new}, π_{sender}, π_{recipient}).

Alternatively, the steps performed by the recipient device 104 are able to be omitted and the transfer message is able to be send to the open registry 106 instead of the recipient device for verification. In either case, the smart contract of the registry 106 then verifies both the transfer function proof and the transfer artifact function proof against the transfer fingerprint and new item ownership fingerprint using the verification function, verifies that the root rt of the merkle tree exists, and verifies whether transfer fingerprint and new item ownership fingerprint have been used before. Specifically, the smart contract will rejection the transaction if the verification function indicates that one or both of the proofs with the instances do not satisfy the NP statements, if the indicated root rt is not found on the merkle tree, or if the new item ownership fingerprint and/or transfer fingerprint has been used before (e.g. is already stored on the key value storage). For example, if given a transaction tx=tx_{transfer}, the smart contract is able to verify the transaction by:
parsing tx_{transfer} as (rt, sn, iof_{new}, π_{sender}, π_{recipient}),
verifying that the transfer fingerprint sn does not already appear on the key value storage;
verifying that the iof_{new} does not already appear on the merkle tree;
verifying that the root rt does appear on the merkle tree;
verifying that Verify(sender verification key, instance x, proof π_{sender})=accepted for the NP statement, where instance x=(rt, sn, iof_{new}); and
verifying that Verify(recipient verification key, iof_{new} proof π_{recipient})=accepted for the NP statement.

If all verifications are passed the transaction is appended to the ledger and new item ownership fingerprint is stored in the merkle tree (either replacing or indirectly superseding the previous item ownership fingerprint), otherwise, it is rejected. It does not supersede the previous fingerprint directly (because that would link the new fingerprint with the previous one), but it does indirectly because the transfer artifact is stored and so it will not be possible to use anymore. Additionally, as described above, the transfer fingerprint sn is able to be appended to the key value storage such that the registry 106 is able to compare new transfer fingerprints to existing transfer fingerprints on the key value storage to ensure that the same transfer fingerprint is not used twice. As a result, the system 100 provides the benefit of enables transactions to occur without revealing the existing/prior item/registrant identifiers (iof_{old}) or the identities of the sender or recipient. Further, as described above, the sender is unable to determine when or whether the recipient subsequently further transfer the item 102.

### Revealing Sender Identity

The transfer protocol does not entail disclosure of the sender's public key to a recipient, but information available in the transfer message, sn, in particular, allows one to reveal the public key of the sender and a respective proof 7C sender for the NP statement SENDER. In particular, this is a way to reveal the sender identity, while maintaining the advantage of not revealing from which old item fingerprint it is coming from, therefore recipient will not know when sender has registered/received the item. In such embodiments, the agent 107 of the recipient device 104 requests the identity from the sender device 104 for the particular transfer fingerprint sn through a private communication channel. The sender device 104 is then able to produce proof of the SENDER NP statement:

“Given transfer fingerprint sn and sender pubic key, I know unit u_{old} and secret key of the sender such that:
the sender address secret key corresponds to the public key: (i.e. aᵣₖ=public key function PRFaₛₖ(0), where aₛₖ is the secret key of the sender); and
the transfer fingerprint sn is computed correctly: sn=transfer artifact function PRFaₛₖ(iof_{old}∥p_{old}), where aₛₖ is the secret key of the sender).”
   Explicitly, the instance tuple is (sn, aᵣₖ) where aᵣₖ is the public key of the sender, the witness tuple is (iof_{old}, aₛₖ of sender, p_{old}) and the resulting message is able to comprise m_{identity}=(aᵣₖ of sender, π_{sender}).

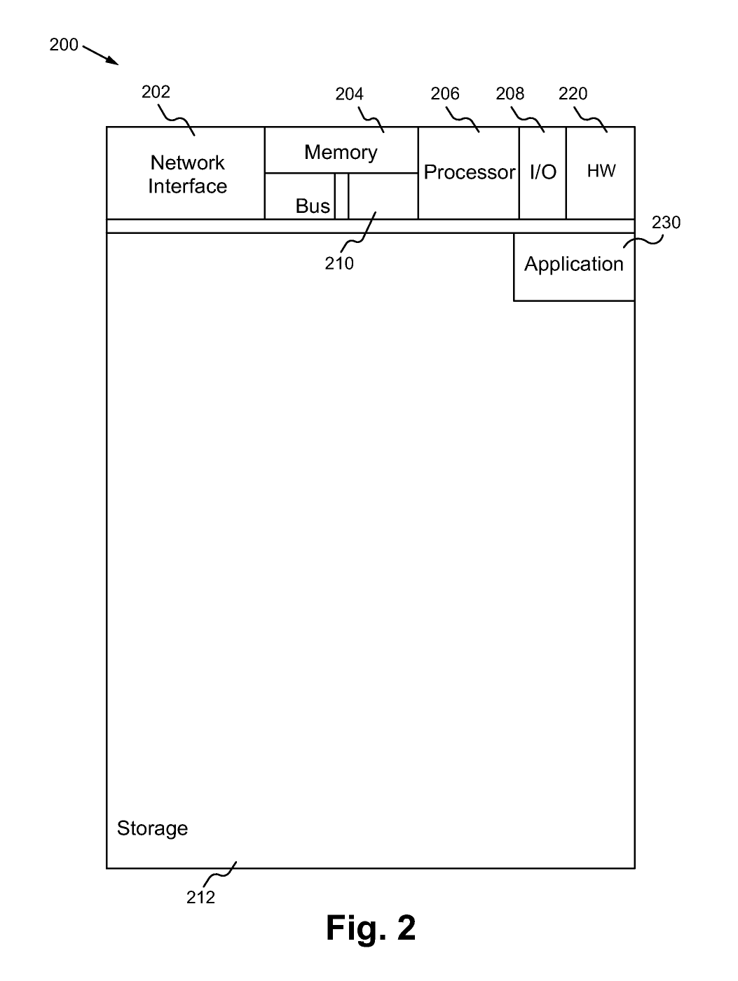

FIG. 2 illustrates a block diagram of an exemplary computing device 200 configured to implement the system 100 according to some embodiments. In addition to the features described above, nodes 105, the transfer devices 104 and/or servers 108 are able to be substantially similar to the device 200. In general, a hardware structure suitable for implementing the computing device 200 includes a network interface 202, a memory 204, a processor 206, I/O device(s) 208 (e.g. reader), a bus 210 and a storage device 212. Alternatively, one or more of the illustrated components are able to be removed or substituted for other components well known in the art. The choice of processor is not critical as long as a suitable processor with sufficient speed is chosen. The memory 204 is able to be any conventional computer memory known in the art. The storage device 212 is able to include a hard drive, CDROM, CDRW, DVD, DVDRW, flash memory card or any other storage device. The computing device 200 is able to include one or more network interfaces 202. An example of a network interface includes a network card connected to an Ethernet or other type of LAN. The I/O device(s) 208 are able to include one or more of the following: keyboard, mouse, monitor, display, printer, modem, touchscreen, button interface and other devices. The agent 107 or function(s)/module(s) thereof are likely to be stored in the storage device 212 and memory 204 and processed as applications are typically processed. More or fewer components shown in FIG. 2 are able to be included in the computing device 200. In some embodiments, secure transfer system hardware 220 is included. Although the computing device 200 in FIG. 2 includes applications 230 and hardware 220 for the system 100, the system 100 is able to be implemented on a computing device in hardware, firmware, software or any combination thereof.

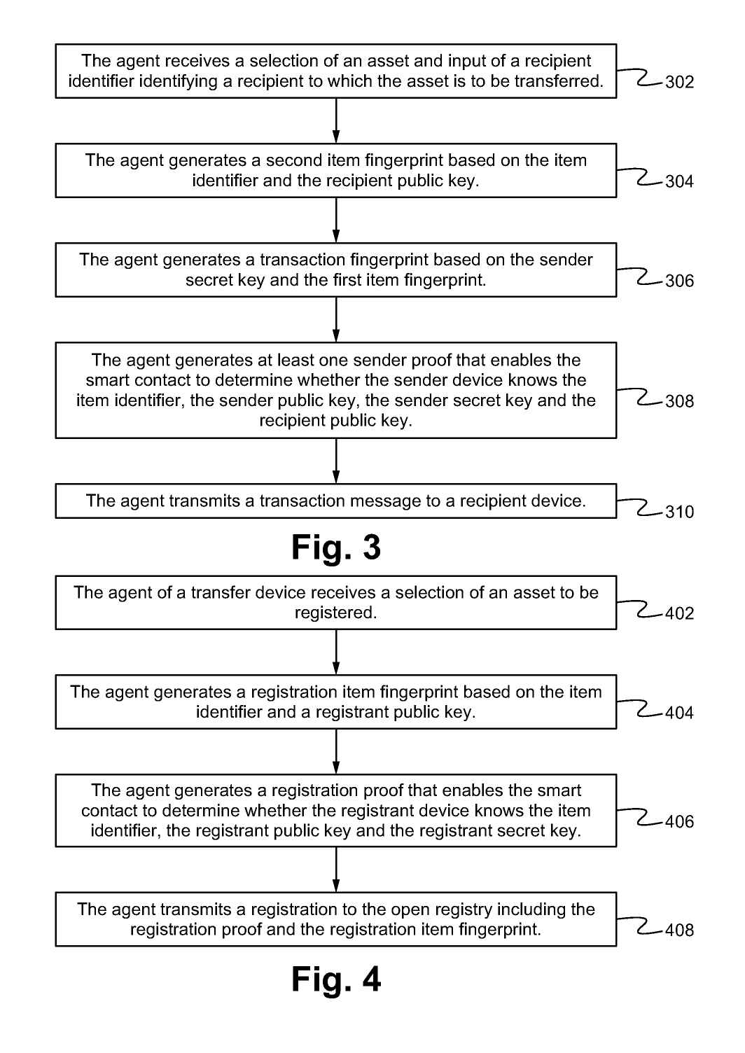

FIG. 3 illustrates a method of operating a secure transfer system 100 according to some embodiments. As shown in FIG. 3, an agent 107 of the transfer device 104 receives a selection of an asset and input of a recipient identifier identifying a recipient to which the asset is to be transferred at the step 302. The agent 107 of the transfer device 104 generates an item's second fingerprint based on the item identifier and the recipient public key at the step 304. The agent 107 of the transfer device 104 generates a transfer fingerprint based on the sender secret key and the item's first fingerprint at the step 306. The agent 107 of the transfer device 104 generates at least one sender proof that enables the blockchain to determine whether the sender device knows the item identifier, the sender secret key, the sender secret key and the recipient public key at the step 308. The agent 107 of the transfer device 104 transmits a transaction message to a recipient device 104 having a second transfer agent 107, the transaction message including the sender proof, the item's second fingerprint and the transfer fingerprint at the step 310.

In some embodiments, upon receipt of the transaction message by the recipient device 104, the recipient device 104 generates at least one recipient proof that enables the smart contract to determine whether the recipient device 104 knows the item identifier and the recipient secret key and transmits a transfer transaction to the open registry 106 including the recipient proof, the sender proof, the item's second fingerprint and the transfer fingerprint. In some embodiments, the smart contract on the open registry 106 verifies whether the sender device 104 knows the item identifier, the sender public key, the sender secret key and the recipient public key based on the sender proof and verifies whether the recipient device 104 knows the item identifier and the recipient secret key based on the recipient proof. In some embodiments, the smart contract refrains from recording the transfer transaction on the ledger if the transfer fingerprint already exists on the key-value storage. In some embodiments, the blockchain refrains from recording the transfer transaction on the ledger if the item's second fingerprint already exists on the accumulator. The agent 107 of the transfer device 104 identifies a root value on the accumulator (e.g. merkle tree) and the blockchain refrains from recording the transfer transaction on the ledger if the leaf that represents the fingerprint does not belong to the accumulator.

FIG. 4 illustrates a method of operating a secure transfer system 100 according to some embodiments. As shown in FIG. 4, an agent 107 of the transfer device 104 receives a selection of an asset to be registered at the step 402. The agent 107 of the transfer device 104 generates a registration item fingerprint based on the item identifier and a registrant public key of a registrant having a registrant secret key that corresponds to the registrant public key at the step 404. The agent 107 of the transfer device 104 generates a registrant proof that enables the blockchain to determine whether the registrant device 104 knows the item identifier, the registrant public key and the registrant secret key at the step 406. The agent 107 of the transfer device 104 transmits a registration transaction to the open registry 106 including the registration proof and the registration item fingerprint at the step 408. In some embodiments, the method further comprises verifying with the smart contract on the open registry 106 whether the sender device 104 knows the item identifier, the registrant public key and the registrant secret key based on the registrant proof. In some embodiments, the method further comprises refraining from recording the registration transaction on the ledger on the open registry 106 if the registrant item fingerprint already exists on the accumulator. In some embodiments, the leaf that represents the item's first fingerprint is able to be verified against some of the previous versions of the accumulator (e.g. merkle tree) in order to allow multiple transactions to be processed in parallel.

### Advantages

The described system, method and device has numerous advantages. For example, using the system 100, nobody can register a unit on another's behalf, due to the fact that unit identity id carries registrant's public key (aᵣₖ) and due to the way the registration NP statement is constructed, it requires knowledge of the registrant's secret key (aₛₖ). As a result, the transfer recipient will always be able to identify unit registrant's identity. Further, nobody, besides the current owner/custodian, is able to transfer a unit 102 because one has to know the secret key of the sender due to the way the origin NP statement is formed. Additionally, nobody can transfer an item 102 to another party unless that party approves of the transfer because of the way the transfer transactions are constructed it requires proofs of both the origin and the destination NP statements (hence knowledge of recipient's secret key is required).

Moreover, it should be noted that in the transfer interaction the sender and recipient are sharing no innate secret information, which would allow them to act on each other's behalf. This is due to the fact that transfer requires two isolated NP statements one from the sender (ORIGIN) and one from the recipient (DESTINATION), wherein the message of the sender to the recipient m_{transfer} has no secrets of sender or recipient and there's no reference to the source item ownership fingerprint iof_{old}. Also, all registration transactions look the same since the only data it includes is a unit ownership fingerprint and a proof (which reveals no information about the registrant or the item 102). Similarly, all transfer transactions look the same because the only thing they include apart from the proofs is a transfer fingerprint and an iof, both of which reveal no information about participants or units 102.

There's mutual blindness between parties of the transfer transaction. The recipient cannot learn how many transfers unit has made prior to him, what were the dates of those transfers and what are the identities of the parties, since he has no information to compute previous unit commitments, nor there's any counter of the transfers in the protocol. The sender can only learn if the unit is transferred successfully to the recipient by checking transfer fingerprint sn on the key value storage, but he cannot learn whether or when recipient has transferred the unit to a next party, including identities of those party(ies), since in order to compute a new recipient's transfer fingerprint sn of the unit one needs to know secret key of the recipient. Accordingly, granular provenance disclosure is achieved wherein the receiving party cannot provably disclose the sender's identity (e.g. the public key of the sender) unless “Revealing Identity of the Sender” protocol is executed. In the same vein, the sending party can only disclose recipient's identity they transferred to, but have no visibility over next recipients in the supply chain.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims. For example, in some embodiments the devices 104 are able to be integrated into supply chain equipment (e.g., bar code scanner, optical character recognition (OCR) readers, RFID readers, near field communication (NFC) readers, convey belts, packaging machines) that is able to read and/or write data to the targeted open registry 106, tags and/or servers 108.

Further, item 102 is able to be a digital asset (e.g., a token, an identifier, a group of identifiers) or the digital twin of a physical asset that exists in the physical world and/or the ledger/registry record is able to be transfer of custody, transfer of ownership, transfer of use and transfer of rights. Therefore, “possession” as described herein is able to represent any type of assignment that can be transferred, including “custody”, “ownership”, “right” and “responsibility”. In some embodiments, the system 100 is able to require fingerprint generation process to use enough entropy (randomness) for each separate fingerprint since identity might have short brute-force space. Additional randomness is also able to be used to make multiple instances of ownership available to the same participant by obtaining different unit ownership fingerprints. This is beneficial in multiple use cases including transfers returned to a previous owner. Furthermore, this provides unlinkability amongst chains of transfers that involve the same participant more than once per unit.

Moreover, it is possible for a sender device 104 to invalidate a transfer before it has been sent to the registry 106 by the recipient device 104 (e.g. in cases such as mistake, for example, units were authorized but haven't been shipped). To disable such an authorization (e.g. credentials necessary for transfer, sent by message m_{transfer}) the sender device 104 would need to generate another transfer, the same way with the exception that it is sent to oneself (i.e. same address (public key of the recipient)=(public key of the sender) and broadcast transfer transaction to the registry 106. This will cause the blockchain to record the current transfer fingerprint sn on the key value storage and thus result in that transfer fingerprint being already “consumed.” As a result, when the message from the recipient device 104 is subsequently received, the transaction will be rejected because the transfer fingerprint will be invalid (e.g. already used).

What is claimed is:

1. A blockchain and digital ownership transfer authentication system for transferring digital identities of items from a sender to a recipient, wherein the sender has a sender secret key and a sender public key that is derived from the sender secret key and the recipient has a recipient secret key and a recipient public key that is derived from the recipient secret key, the system comprising:
a blockchain including a key-value storage that stores transfer fingerprints and an accumulator that stores the digital identities of the items, wherein each of the digital identities includes an item's first fingerprint that is derived from an item identifier, the sender public key of the sender that is a current custodian of the item and a corresponding randomness entropy value;
a sender device storing a first transfer agent; and
a recipient device storing a second transfer agent, wherein upon selection of a transfer feature by the sender on the sender device, the first transfer agent:
generates an item's second fingerprint based on the item identifier and the recipient public key;
generates a transfer fingerprint based on the sender secret key and the item's first fingerprint, wherein the transfer fingerprint uniquely identifies the transaction;
generates at least one sender proof that enables the blockchain to determine whether the sender device knows the item identifier, the sender secret key and the recipient public key and the corresponding randomness entropy value; and
transmits a transaction message to the recipient device including the sender proof, the item's second fingerprint and the transfer fingerprint.

2. The system of claim 1, wherein upon receipt of the transaction message by the recipient device, the second transfer agent:
generates at least one recipient proof that enables the blockchain to determine whether the recipient device knows the item identifier and the recipient secret key; and
transmits a transfer transaction to the blockchain including the recipient proof, the sender proof, the item's second fingerprint and the transfer fingerprint.

3. The system of claim 2, wherein the blockchain verifies whether the sender device knows the item identifier, the sender public key, the sender secret key and the recipient public key based on the sender proof and verifies whether the recipient device knows the item identifier and the recipient secret key based on the recipient proof.

4. The system of claim 3, wherein the blockchain refrains from recording the transfer transaction on the accumulator if the transfer fingerprint already exists on the key-value storage.

5. The system of claim 4, wherein the blockchain refrains from recording the transfer transaction on the accumulator if the item's second fingerprint already exists on the accumulator.

6. The system of claim 5, wherein the accumulator is an append-only merkle tree in which each of the digital identities is a leaf of the merkle tree.

7. The system of claim 6, wherein the first transfer agent identifies a merkle tree root value and the blockchain refrains from recording the transfer transaction on the accumulator if a leaf that represents the transfer fingerprint does not belong to the merkle tree.

8. The system of claim 7, wherein the item identifier is a tuple comprising a unique identifier value and the registrant public key.

9. The system of claim 8, further comprising a registrant device storing a registration agent, wherein upon selection of a registration feature by a registrant, the registration agent:
generates a registration item fingerprint based on the item identifier and a registrant public key of a registrant having a registrant secret key that corresponds to the registrant public key;
generates a registrant proof that enables the blockchain to determine whether the registrant device knows the item identifier, the registrant secret key and the corresponding randomness entropy value; and
transmits a registration transaction to the blockchain including the registration proof and the registration item fingerprint.

10. The system of claim 9, wherein the blockchain verifies whether the sender device knows the item identifier, the registrant public key and the registrant secret key based on the registrant proof.

11. The system of claim 10, wherein the blockchain refrains from recording the registration transaction on the accumulator if the registrant item fingerprint already exists on the accumulator.

12. A digital ownership transfer authentication device for transferring digital identities of items from a sender to a recipient on a blockchain, the blockchain including a key-value storage that stores transfer fingerprints and an accumulator that stores the digital identities of the items, wherein each of the digital identities includes an item's first fingerprint that is derived from an item identifier, the sender public key of the sender that is a current custodian of the item and a corresponding randomness entropy value, wherein the sender has a sender secret key and a sender public key that is derived from the sender secret key and the recipient has a recipient secret key and a recipient public key that is derived from the recipient secret key, the device comprising:
a non-transitory computer-readable memory storing a transfer agent having a graphical user interface and including transfer and registration functions; and
a processing circuit coupled with the memory, wherein when executed by the processing circuit and upon selection of a transfer feature when the sender is logged into the transfer agent, the transfer agent:
generates an item's second fingerprint based on the item identifier and the recipient public key;
generates a transfer fingerprint based on the sender secret key and the item's first fingerprint, wherein the transfer fingerprint uniquely identifies the transaction;
generates at least one sender proof that enables the blockchain to determine whether the sender device knows the item identifier, the sender secret key, the recipient public key and the corresponding randomness entropy value; and
generates a transaction message including the sender proof, the item's second fingerprint and the transfer fingerprint.

13. The device of claim 12, wherein upon receipt of the transaction message from a sender device when the recipient is logged into the transfer agent, the transfer agent:
generates at least one recipient proof that enables the blockchain to determine whether the transfer agent knows the item identifier and the recipient secret key; and
transmits a transfer transaction to the blockchain including the recipient proof, the sender proof, the item's second fingerprint and the transfer fingerprint.

14. The device of claim 13, wherein the blockchain verifies whether the sender device knows the item identifier, the sender public key, the sender secret key and the recipient public key based on the sender proof and verifies whether the recipient device knows the item identifier and the recipient secret key based on the recipient proof.

15. The device of claim 14, wherein the accumulator is organized into an append-only merkle tree in which each of the digital identities is a leaf of the merkle tree and when the sender is logged into the transfer agent, the transfer agent identifies a merkle tree root value and includes the merkle tree root value in the transaction message.

16. The device of claim 15, wherein the item identifier is a tuple comprising a unique identifier value and the registrant public key.

17. The device of claim 16, wherein when a registrant is logged into the transfer agent and selects a registration feature, the transfer agent:
generates a registration item fingerprint based on the item identifier and a registrant public key of a registrant having a registrant secret key that corresponds to the registrant public key;
generates registrant proof that enables the blockchain to determine whether the registrant device knows the item identifier, the registrant secret key and the corresponding randomness entropy value; and
transmits a registration transaction to the blockchain including the registration proof and the registration item fingerprint.

18. A method of implementing a blockchain and digital ownership transfer authentication system for transferring digital identities of items from a sender to a recipient on a blockchain, the blockchain including a key-value storage that stores transfer fingerprints and an accumulator that stores the digital identities of the items, wherein each of the digital identities includes an item's first fingerprint that is derived from an item identifier, the sender public key of the sender that is a current custodian of the item and a corresponding randomness entropy value, wherein the sender has a sender secret key and a sender public key that is derived from the sender secret key and the recipient has a recipient secret key and a recipient public key that is derived from the recipient secret key, the method comprising:
generating with a sender device having a first transfer agent an item's second fingerprint based on the item identifier and the recipient public key;
generating with the sender device a transfer fingerprint based on the sender secret key and the item's first fingerprint, wherein the transfer fingerprint uniquely identifies the transaction;
generating with the sender device at least one sender proof that enables the blockchain to determine whether the sender device knows the item identifier, the sender secret key, the recipient public key and the corresponding randomness entropy value; and
transmitting with the sender device a transaction message to a recipient device having a second transfer agent, the transaction message including the sender proof, the item's second fingerprint and the transfer fingerprint.

19. The method of claim 18, further comprising, upon receipt of the transaction message by the recipient device:
generating with the recipient device at least one recipient proof that enables the blockchain to determine whether the recipient device knows the item identifier and the recipient secret key; and
transmitting with the recipient device a transfer transaction to the blockchain including the recipient proof, the sender proof, the item's second fingerprint and the transfer fingerprint.

20. The method of claim 19, further comprising verifying with the blockchain whether the sender device knows the item identifier, the sender public key, the sender secret key and the recipient public key based on the sender proof and verifying whether the recipient device knows the item identifier and the recipient secret key based on the recipient proof.

21. The method of claim 20, further comprising refraining from recording the transfer transaction on the accumulator if the transfer fingerprint already exists on the key-value storage.

22. The method of claim 21, further comprising refraining from recording the transfer transaction on the accumulator if the item's second fingerprint already exists on the accumulator.

23. The method of claim 22, wherein the accumulator is an append-only merkle tree in which each of the digital identities is a leaf of the merkle tree.

24. The method of claim 23, further comprising identifying a merkle tree root value with the first transfer agent and refraining from recording the transfer transaction on the accumulator if a leaf that represents the transfer fingerprint does not belong to the merkle tree.

25. The method of claim 24, wherein the item identifier is a tuple comprising a unique identifier value and the registrant public key.

26. The method of claim 25, further comprising upon selection of a registration feature of a registration agent on a registrant device by a registrant:
generating with the registrant device a registration item fingerprint based on the item identifier and a registrant public key of a registrant having a registrant secret key that corresponds to the registrant public key;
generating with the registrant device a registrant proof that enables the blockchain to determine whether the registrant device knows the item identifier, the registrant secret key and the corresponding randomness entropy value; and
transmitting with the registrant device a registration transaction to the blockchain including the registration proof and the registration item fingerprint.

27. The method of claim 26, further comprising verifying with the blockchain whether the sender device knows the item identifier, the registrant public key and the registrant secret key based on the registrant proof.

28. The method of claim 27, further comprising refraining from recording the registration transaction on the accumulator if the registrant item fingerprint already exists on the accumulator.
